(19) United States
(12) Patent Application Publication
(10) Pub. No.: US 2013/0163119 A1
(43) Pub. Date: Jun. 27, 2013

(54) Head-Media Interface in a Hard Disk Drive

(71) Applicants: Charanjit Signh Bhatia, Singapore (SG); Abdul Samad Mohammed, Singapore (SG)

(72) Inventors: Charanjit Signh Bhatia, Singapore (SG); Abdul Samad Mohammed, Singapore (SG)

(73) Assignee: NATIONAL UNIVERSITY OF SINGAPORE, Singapore, SG (SG)

(21) Appl. No.: 13/821,233

(22) PCT Filed: Sep. 7, 2011
(86) PCT No.: PCT/SG2011/000303

§ 371 Date: Mar. 6, 2013

Related U.S. Application Data
(60) Provisional application No. 61/380,398, filed on Sep. 7, 2010.

(51) Int. Cl. G11B 5/60

(52) U.S. Cl. CPC G11B 5/6005
USPC 360/234; 427/523; 427/527; 427/531

(57) ABSTRACT

A hard disk drive comprising a mixed layer is provided to reduce the head-media spacing in the hard disk drive by embedding a surface of a magnetic recording medium or head of the hard disk drive with energetic ions. The mixed layer provides sufficient protection against corrosion and wear of the magnetic layer of the magnetic recording medium without requiring any DLC and/or lubricant overcoat.

### TECHNICAL FIELD

The present invention relates to a magnetic recording device, particularly to a hard disk drive, as well as to a method of treating a surface of the magnetic recording device.

### BACKGROUND

Hard disk drives comprise a magnetic medium and a read-write head, flying a few nanometers above the surface of the magnetic medium, responsible for writing and recovering the recorded data on the disk drive. Surfaces of the magnetic medium and the head require to be protected against corrosion and mechanical damages such as wear and tear especially when intermittent contact happens between the head and the magnetic medium. The present form of this protection is coating these surfaces with overcoats of a thin, continuous and hard material and a lubricant layer. The lubricant layer acts as an additional corrosion barrier and also lowers the friction between the head and the magnetic medium when any contact between the two happens.

The demand for higher areal densities (number of bits/unit area on a disk surface) in the magnetic hard disk drives has been consistently increasing. One way of achieving higher areal density is to reduce the head-media spacing (HMS) between the head and the magnetic medium. This can be done by reducing the flying height, or the thickness of the lubricant or protective layers. Either of these options creates technical challenges to implement.

### SUMMARY OF THE INVENTION

The present invention seeks to address these problems, and/or to provide an improved magnetic recording device, particularly a hard disk drive.

In general terms, the invention relates to embedding ions in a surface of a magnetic recording device to form a mixed layer. The surface may be in the head or magnetic recording medium of a hard disk drive. The surface may also be a head of a magnetic tape drive or it may be any other surface needing protection against corrosion or mechanical damage for which increased adhesion or lower friction may be desirable.

According to a first aspect, the present invention provides a method comprising embedding energetic ions in a surface of a hard disk drive to form a mixed layer.

The energetic ions may be any suitable energetic ions. For example, the energetic ions may be selected from the group consisting of: carbon ions, silicon ions, titanium ions, chromium ions, and a combination thereof. In particular, the energetic ions are carbon ions.

The embedding may be by any process suitable for embedding ions to a surface. For example, the embedding may be by filtered cathodic vacuum arc (FCVA) process, ion implantation, chemical vapour deposition (CVD) or plasma enhanced chemical vapour deposition (PECVD). The embedding may comprise embedding the energetic ions to a depth of ≦2 nm in the surface of the hard disk drive. In particular, the energetic ions may be embedded to a depth of ≦1 nm. Even more in particular, the energetic ions may be embedded to a depth of about 0.25-1 nm.

The method may further comprise depositing a protective layer on the mixed layer. The depositing may comprise depositing the protective layer to a thickness of ≦0.5 nm.

The method may further comprise depositing a lubricant layer on the mixed layer. Alternatively, the method may further comprise depositing a lubricant layer on the protective layer. The depositing may comprise depositing the lubricant layer to a thickness of ≦2 nm.

The method of the first aspect may be applied to existing hard disk drives or to future hard disk drives to achieve higher areal densities.

According to a second aspect, the present invention provides a hard disk drive comprising a mixed layer prepared according to the method described above.

According to a third aspect, the present invention provides a hard disk drive comprising a magnetic recording medium and a head, wherein the magnetic recording medium and/or the head comprises a mixed layer embedded in the magnetic recording medium or the head.

The mixed layer may be formed from the method as described above.

The magnetic recording medium may comprise:
a substrate; and
a magnetic layer disposed on the substrate,
   wherein the magnetic layer comprises two layers, a lower magnetic layer of magnetic medium for recording information contacting the substrate and the mixed layer on the lower magnetic layer.

The mixed layer may have a thickness of ≦2 nm. In particular, the mixed layer may have a thickness of ≦1 nm. Even more in particular, the mixed layer may have a thickness of about 0.25-1 nm.

The magnetic recording medium and/or head of the hard disk drive may further comprise a lubricant layer disposed on the mixed layer. The lubricant layer may have a thickness of ≦2 nm. The lubricant layer may be composed of any suitable material such as perfluoropolyethers, perfluoropolyalkylethers, or combinations thereof.

The magnetic recording medium and/or head of the hard disk drive may further comprise a protective layer disposed on the mixed layer. For example, the protective layer may be disposed between the mixed layer and the lubricant layer. The protective layer may have a thickness of ≦0.5 nm.

The magnetic recording medium may have a coefficient of friction of ≦0.4. In particular, the coefficient of friction of the magnetic recording medium is in the range 0.1-0.4.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a cross-sectional view of a hard disk drive comprising a magnetic recording medium and a head according to a particular embodiment of the present invention;

FIG. 2 shows a process flow of a method for preparing a magnetic recording medium according to a particular embodiment of the present invention;

FIG. 3 shows a XPS spectrum of the depth analysis of a magnetic recording medium according to a particular embodiment of the present invention;

FIG. 4 shows a configuration of a ball-on-disk used for performing tribological tests on a magnetic recording medium according to a particular embodiment of the present invention;

FIG. 5 shows a graph of the coefficient of fraction of four different types of magnetic recording medium;

FIGS. 6(A) and 6(B) show a plot of the wear track of two different magnetic recording medium;

FIG. 7(A) shows the XPS spectrum showing the oxidation resistance of a mixed layer formed according to one embodiment of the present invention and FIG. 7(B) shows the % atomic concentration of surface oxygen of different magnetic recording medium; and

FIGS. 8(A) and 8(B) show the conductive atomic force microscopy (CAFM) images of two different magnetic recording medium.

### DETAILED DESCRIPTION

The present invention provides a hard disk drive. The hard disk drive according to the present invention may have a higher areal density compared to conventional hard disk drives.

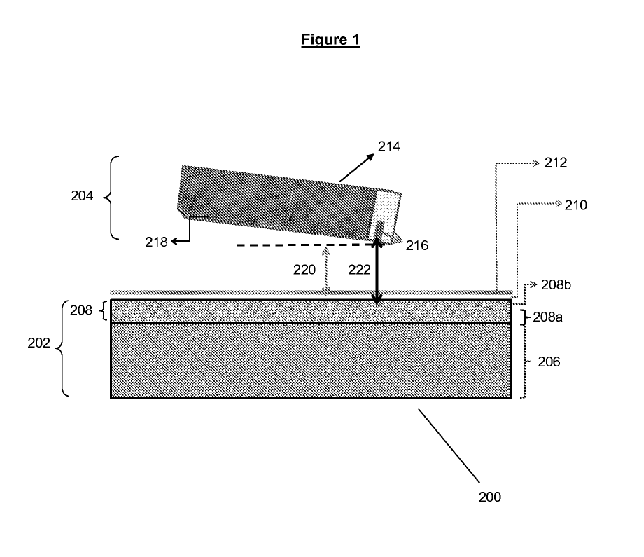

FIG. 1 shows a hard disk drive 200 comprising a magnetic recording medium 202 and a read-write head 204.

The read-write head 204 comprises a slider 214 and a read-write element 216. The slider 214 of the read-write head 204 comprises a mixed layer 218. The mixed layer 218 will be described in more detail below. The read-write head 204 may be of any suitable material such as Al₂O₃—TiC (AlTiC).

The magnetic recording medium 202 comprises a substrate 206 and a magnetic layer 208 disposed on the substrate 206. The magnetic recording medium 202 may also comprise an optional protective layer 210 and an optional lubricant layer 212 disposed on the magnetic layer 208.

The magnetic layer 208 is comprised of two layers, a lower magnetic layer 208a of magnetic medium for recording information and a mixed layer 208b. The lower magnetic layer 208a contacts the substrate 206. The mixed layer 208b is on the lower magnetic layer 208a.

Information is written to and read from the magnetic recording medium 202 as the read-write head 204 moves across the magnetic recording medium 202. The distance between the top surface of the magnetic recording medium 202 and the read-write head 204 is defined as the flying height 220. The vertical distance between the read-write element 216 of the read-write head 204 and the surface of the lower magnetic layer 208a closest to the read-write head 204 is defined as a head-media spacing (HMS) 222. The HMS 222 is the sum of the flying height 220 and the thickness of the optional lubricant layer 212, the optional protective layer 210, and the thickness of the mixed layer 208b.

The substrate 206 may be any suitable substrate. In particular, the substrate may be a non-magnetic substrate. For example, the substrate may be made of glass or glass-ceramic, metal alloys such as aluminium alloys and NiP/Al, plastic or polymer material, ceramic, glass-polymer, composite materials or other non-magnetic materials.

The magnetic medium of the lower magnetic layer 208a may be composed of any suitable material. For example, the magnetic medium may be composed of any one of, but not limited to, cobalt, chromium, iron, platinum, or combinations thereof, such as a cobalt-based alloy, a chromium-based alloy or a iron-based alloy, like Co—Cr—Pt or FePt.

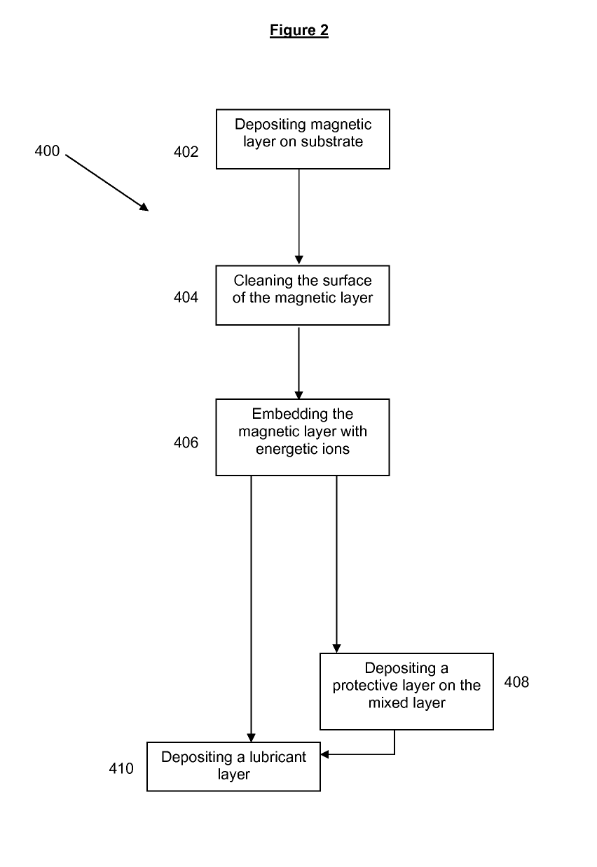

The mixed layer 208b is formed after the magnetic layer 208 is embedded with energetic ions. Similarly, the mixed layer 218 is formed after the surface of the slider 214 is embedded with energetic ions. The embedding of the energetic ions to the surface of the magnetic layer 208 and to the surface of the slider 214 will be described in detail in relation to steps 406 and 408 of FIG. 2.

The mixed layer 208b may have any suitable thickness. In particular, the mixed layer 208b may have a thickness of ≦2 nm. Even more in particular, the mixed layer may have a thickness of ≦1 nm, and more preferably a thickness in the range 0.25-1.0 nm.

Overcoats are provided on magnetic layers of conventional magnetic recording medium for protecting the magnetic medium against corrosion and for lowering the friction during an intermittent contact between the magnetic recording medium and the read-write head. Conventionally, overcoats comprise a thick protective layer of diamond-like carbon (DLC) and a lubricant layer.

The overall thickness of an overcoat may be reduced in the magnetic recording medium 202 since the mixed layer 208b is within the thickness of the magnetic layer of conventional magnetic recording medium, thereby removing the necessity to provide an additional protective layer for protecting the magnetic medium against corrosion.

The optional lubricant layer 212 further reduces wear and friction as a result of intermittent contact between the magnetic recording medium 202 and the read-write head 204 during operation of the hard disk drive 200. The lubricant layer 212 may be composed of any suitable material. The lubricant layer 212 may be composed of mixtures of long chain polymers or oligomers characterized by a wide distribution of molecular weights such as polyethylene and polydimethylsiloxane (PDMS), hydrocarbons such as stearates and fluorocarbons. For example, the lubricant layer 212 may be composed of, but not limited to, perfluoropolyethers (PFPEs), functionalised PFPEs, perfluoropolyalkylethers, functionalised perfluoropolyalkylethers, graphene, and combinations thereof.

The lubricant layer 212 may have any suitable thickness. In particular, the lubricant layer 212 may have a thickness of 0.1-2.0 nm. Even more in particular, the lubricant layer may have a thickness of ≦1 nm.

The magnetic recording medium 202 may comprise an optional protective layer 210 on the magnetic layer 208. The protective layer 210 may be between the magnetic layer 208 and the lubricant layer 212. The protective layer 210 may comprise any suitable material. For example, the protective layer 210 may comprise any one of, but not limited to, carbon or carbides and nitrides of silicon, titanium or boron, or combinations thereof. In particular, the protective layer 210 may comprise DLC.

The protective layer 210 may be of any suitable thickness. In order to maintain a reduced overall thickness of any overcoat provided on the magnetic layer 208, the thickness of the protective layer 210 is, preferably, kept to a minimum. For example, the thickness of the protective layer 210 may be ≦0.5 nm.

The protective layer 210 and the lubricant layer 212 may be provided when additional protective against corrosion and friction is required, over and above the protection provided by the mixed layers 208b and 218.

The coefficient of friction is defined as the ratio of the force that maintains contact between the read-write head 204 and the surface of the magnetic recording medium 202 and the frictional force that resists the motion of the read-write head 204. Accordingly, a lower coefficient of friction would mean there is a higher wear life by reducing the wear and tear on the surfaces of the magnetic recording medium 202 and the read-write head 204. The magnetic recording medium 202 may have a coefficient of friction of <0.4. In particular, the coefficient of friction of the magnetic recording medium may be in the range 0.1-0.4.

The advantage of the magnetic recording medium 202 is that the overall thickness of the overcoats on the magnetic layer 208 is reduced since the magnetic recording medium 202 removes the need to provide a thick DLC layer over the magnetic layer 208 in order to protect the magnetic medium comprised in the magnetic layer 208 against corrosion. This is because the mixed layer 208b is embedded in the magnetic recording medium 202 and thus the mixed layer 208b which is within the thickness of the magnetic layer 208. In particular, the thickness of the magnetic layer 208 remains unchanged compared to the thickness of magnetic layers of conventional magnetic recording medium. Even if an additional protective layer 210 and lubricant layer 212 is deposited on the magnetic layer 208, the thickness of the protective layer 210 and lubricant layer 212 may be reduced compared to the protective layer in a conventional magnetic recoding medium since the mixed layer 208b may provide the adequate protection against corrosion of the magnetic medium and reduces the friction between the read-write head 204 and the magnetic recording medium 202 when the read-write head 204 and the magnetic recording medium 202 contact each other. As a result of a reduction of the thickness of the overcoats, the HMS 222 is reduced. This reduction in the HMS 222 may result in an increase in the areal density of a magnetic recording device comprising the magnetic recording medium 202, such as the hard disk drive 200.

A method 400 of preparing the magnetic recording medium 202 will now be described with reference to FIG. 2.

Step 402 comprises depositing a magnetic layer on a substrate. The magnetic layer and the substrate may be as described above in relation to the magnetic layer 208 and the substrate 206. The step 402 may be carried out by sputtering. The step 402 may be carried out in an inert gas atmosphere, such as an atmosphere of pure argon.

Once the magnetic layer is deposited on the substrate, the surface of the magnetic layer is cleaned according to step 404. The step 404 comprises cleaning the surface of the magnetic layer using a solvent such as isopropyl alcohol (IPA).

The cleaned surface of the magnetic layer is then subjected to a step 406 which comprises embedding the surface of the magnetic layer with energetic ions. The energetic ions may be any suitable energetic ions. For example, the energetic ions may be selected from the group consisting of: carbon ions, silicon ions, titanium ions, chromium ions, and a combination thereof. In particular, the energetic ions may be carbon ions.

The step 406 results in the formation of a mixed layer within the magnetic layer. In particular, after the step 406, the magnetic layer comprises a lower magnetic layer of magnetic medium and a mixed layer. The magnetic medium may be as described above. The lower magnetic layer and the mixed layer may be as described above in relation to the lower magnetic layer 208a and the mixed layer 208b.

The step 406 may comprise embedding the energetic ions to a depth of ≦2 nm in the magnetic layer. In particular, the step 406 may comprise embedding the energetic ions to a depth of ≦1 nm, and more preferably to a depth of 0.25-1.0 nm.

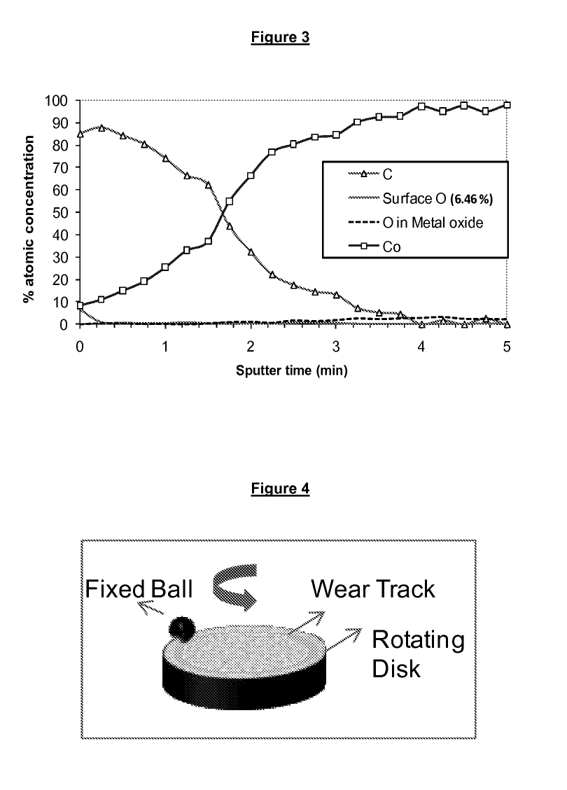

FIG. 3 shows an example of the % atomic concentration down the thickness of the mixed layer after the embedding of the energetic ions, starting from the surface of the mixed layer down towards the surface of the lower magnetic layer. In the example shown in FIG. 3, the atomic concentration is measured relative to the sputtering time as sputtering time is a function of the thickness of the magnetic layer.

It can be seen from FIG. 3 that the concentration of atomic carbon present in the magnetic layer decreases from the mixed layer to the lower magnetic layer. This shows that the energetic ions do in fact get embedded within the magnetic layer to form a mixed layer. The absence of a 100% concentration of atomic carbon at the start of the sputtering indicates that the energetic ions do not deposit on the surface of the magnetic layer but indeed get embedded within the magnetic layer to form a mixed layer.

The step 406 may be by filtered cathodic vacuum arc (FCVA) process. For example, the step 406 may be carried out in a gas atmosphere. The gas atmosphere may be an inert gas atmosphere such as an atmosphere of pure argon or nitrogen.

By using the FCVA process, a uniform distribution of the energetic ions may be achieved in the mixed layer. In particular, the energetic ions may have ion energy in the range of 50-500 eV during the step 406. Preferably, the energetic ions may have an ion energy of about 90-100 eV. The step 406 may be carried out for any suitable period of time. For example, if carbon ions are used as the energetic ions, the step 406 may be carried out for about 50 seconds.

The method 400 further comprises an optional step 408 of depositing a protective layer on the mixed layer of the magnetic layer. The protective layer may be as described above in relation to protective layer 210. In particular, the protective layer may comprise diamond-like carbon (DLC).

The step 408 may be carried out by the FCVA process. For example, the step 408 may be carried out in a gas atmosphere. The gas atmosphere may be an inert gas atmosphere such as an atmosphere of pure argon or nitrogen.

The step 408 may comprise depositing the protective layer to a thickness of ≦0.5 nm.

The method 400 further comprises an optional step 410 of depositing a lubricant layer. If the optional step 408 is carried out, the step 410 comprises depositing the lubricant layer on the protective layer. If the step 408 is omitted from the method 400, the step 410 comprises depositing the lubricant layer on the mixed layer of the magnetic layer. The lubricant layer may be as described above in relation to lubricant layer 212. In particular, the lubricant layer may be composed of polyfluoropolyether (PFPE).

The step 410 may be carried out by a dip-coating process or vapour deposition process. For example, the step 410 may be carried out with or without post-treatment. The post-treatment may comprise heat treatment or treatment with UV to improve the adhesion of the lubricant layer to the protective layer or mixed layer.

The step 410 may comprise depositing the lubricant layer to a thickness of ≦2 nm, for example, 0.1-2.0 nm. In particular, the step 412 may comprise depositing the lubricant layer to a thickness of ≦1 nm.

The method 400 of preparing the magnetic recording medium 202 may be applied similarly to a method of preparing the read-write head 204 comprising the mixed layer 218.

Whilst the foregoing description has described exemplary embodiments, it will be understood by those skilled in the technology concerned that many variations may be made without departing from the present invention. For example, as mentioned the method can equally apply to treating the surface of a head or magnetic recording media of a magnetic tape drive. Thus the mixed layer can also be formed as part of other magnetic recording devices or applied to any surface requiring corrosion or mechanical protection, improvement in adhesion or reduction in friction.

Having now generally described the invention, the same will be more readily understood through reference to the following examples which are provided by way of illustration, and are not intended to be limiting.

### EXAMPLES

### Example 1

An experiment was carried out on four types of magnetic recording medium to investigate the difference in their coefficient of friction.

### Samples

The magnetic layer in each of the four magnetic recording medium was as follows:

(A) A magnetic layer comprising cobalt;

(B) A magnetic layer comprising a lower magnetic layer comprising cobalt and a mixed layer formed by embedding energetic carbon ions in cobalt;

(C) A magnetic layer comprising a lower magnetic layer comprising cobalt and a mixed layer formed by embedding energetic carbon ions in cobalt, and a further lubricant layer composed of perfluoropolyether (Z-Dol 4000); and

(D) A magnetic recording medium of a commercial magnetic recording device comprising a magnetic layer of Co—Cr—Pt—SiO₂, a protective layer comprising DLC (thickness of 2-3 nm) and a lubricant layer comprising PFPE (thickness of 1-2 nm).

### Methods of Preparing Samples

The method used for the preparation of each of samples A, B and C will now be described in more detail.

### (i) Materials and Chemicals

Three square coupons of 1 cm×1 cm of silicon substrate sputtered with about 100 nm of cobalt were used as the substrate. A magnetron sputtering machine was used to deposit the cobalt on the silicon substrate surface under a base pressure of 1×10⁻⁸ Torr. Sample A was obtained at the end of this step.

### (ii) Surface Modification Using the Filtered Cathodic Vacuum Arc (FCVA) Technique

The two remaining square coupons from step (i) were embedded with carbon ions as described above. Surface modification of the cobalt films to form a mixed layer was achieved by using the filtered cathodic vacuum arc (FCVA) technique. The cobalt samples were cleaned using isopropyl alcohol and acetone respectively for 20 minutes in an ultrasonicator before being dried by nitrogen gas. Ar⁺ sputter etching under a working pressure of 7.5×10⁻⁴ Torr and with ion energy of 1 keV was used to remove the oxide layer on the cobalt films. An electric arc between a mechanical trigger and a highly pure (99.999%) graphite target with a continuous arc discharge current of 40 A was used to produce C⁺ plasma. The cleaned samples were then embedded with a pure C⁺ ion flux produced by the FCVA technique under a base pressure of 3×10⁻⁶ Torr and at an incident angle of 90°. Ion energy of 90 eV was used in order to embed the top layer of the cobalt with C⁺ ions. The time of embedding used was 50 s. A negative pulse bias voltage with a frequency of 20 kHz with a duty cycle of 60% was applied to the substrate. Sample B was obtained at the end of step (ii).

(iii) Lubricant Coating

One of the square coupons from step (ii) was subjected to a lubricant coating of PFPE as follows. The PFPE used was Z-dol 4000 dissolved in H-Galden ZV60 solvent. The chemical formulae of Z-dol and H-Galden ZV60 are HOCH₂CF₂O—(CF₂CF₂O)ₚ—(CF₂O)_{q}—CF₂CH₂OH and HCF₂O—(CF₂O)ₚ—(CF₂CF₂O)_{q}—CF₂H, respectively, where the ratio p/q is 2/3.

The square coupon was cleaned by rinsing in H Galden ZV solvent, before coating with Fomblin Zdol 4000. The samples were dip-coated with PFPE (0.2 wt. % Zdol 4000 in H Galden ZV solvent) using a custom built dip-coating machine which could submerge and withdraw the coupon at a speed of 1.7 mm/s. The coupon was held in the PFPE solution for 1 minute in submerged condition prior to withdrawal. The PFPE coated sample was cured at a temperature of 120° C. for 1 hour to control the thickness of the bonded Zdol. To obtain a greater fraction of the bonded lubricant on the surface, the sample was rinsed mildly in H Galden ZV solvent after the annealing process. The bonded Zdol is defined as the lubricant layer that remained attached after rinsing with the solvent. Sample C was thus obtained from step (iii).

### Experiment Protocol

Ball-on-disc wear tests were carried out for each of samples A to D on a CSM-Nanotribometer (CSM, Switzerland). The configuration of the ball-on-disc used for the test was as shown in FIG. 4. A silicon nitride ball of φ2 mm with a surface roughness of 5 nm (as provided by the supplier) was used as a counterface material. The ball was thoroughly cleaned with acetone before each test. The wear track radius was fixed at 1 mm for all the tests. Wear tests were conducted at a constant normal load of 20 mN corresponding to a contact pressure of 0.26 GPa and a constant rotational speed of 100 rpm. After each test, the counterface and sample surfaces were examined under an optical microscope to investigate the wear mechanisms. Tests were carried out in a clean booth environment (class 100) at a temperature of 25±2° C. and a relative humidity of 55±5%. At least three repetitions were carried out and the average values of coefficient of friction were obtained.

### Results

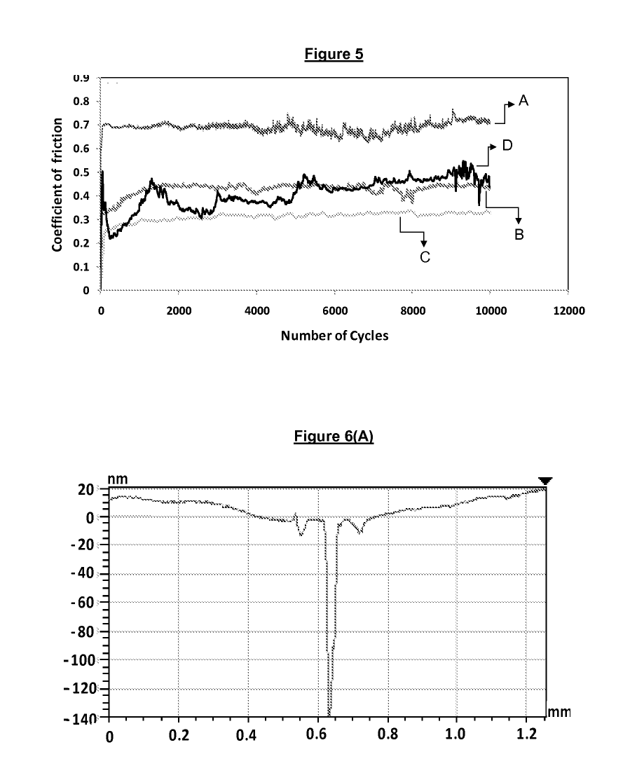

FIG. 5 illustrates the coefficients of friction of each of the four samples A to D.

As seen from FIG. 5, providing a mixed layer resulted in a lower coefficient of friction compared to when the magnetic layer comprises only cobalt. Provision of the lubricant layer together with the mixed layer further reduced the coefficient of friction.

The lower coefficient of friction is mainly due to the improvement in the mechanical properties as a result of the carbon embedding to form the mixed layer and in the provision of the lubricant layer.

### Example 2

An experiment was carried out using samples A and B of Example 1 to investigate the difference in the wear resistance of the samples. In particular, optical profilometry was conducted across the wear tracks formed after a test of 5000 cycles using the configuration as shown in FIG. 4 on both samples A and B. FIG. 6(A) shows the 2-D plot across the wear track of sample A while FIG. 6(B) shows the 2-D plot across the wear track of sample B.

As seen from FIGS. 6(A) and 6(B), the wear track formed on the surface of sample A was estimated to be about 140 nm. However, for sample B, the wear track was hardly visible showing only minor morphological changes after 5000 cycles. This can be attributed to the improvement in the elastic properties such as increased yield stress of the surface of sample B.

### Example 3

An experiment was carried out on samples A and B of Example 1 to analyse the surface of the samples, particularly to investigate the oxidation resistance of the mixed layer.

Kratos Analytical AXIS HSi XPS was used for the analysis. XPS (Al Kα source) imaging was performed on each of samples A and B with an x-ray source (1486.6 eV photons) at a constant dwell time of 100 ms and pass energy of 40 eV. The core level signals were obtained for each sample at a photoelectron take-off angle of 90° with respect to the sample surface.

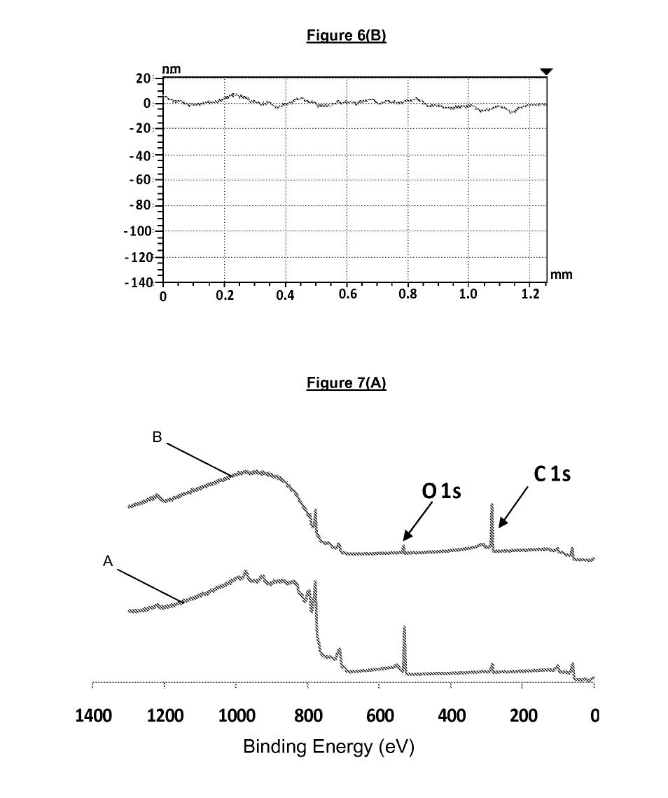

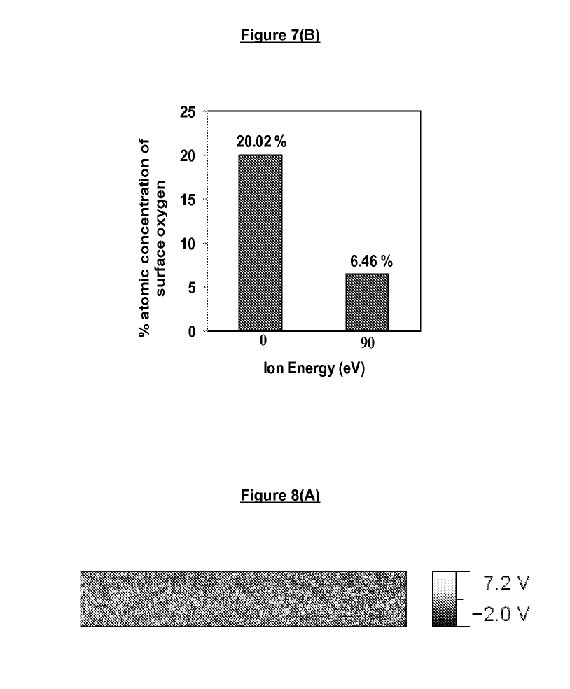

As seen from FIGS. 7(A) and (B), the atomic concentration of oxygen atom is significantly reduced from 20.02% (sample A) to 6.46% (sample B) when the cobalt magnetic layer is embedded with energetic carbon ions to form the mixed layer. Accordingly, it can be concluded that the oxidation resistance of the magnetic layer is improved with the provision of the mixed layer.

### Example 4

An experiment was carried out on samples A and B of Example 1 to analyse the surface topography of the samples, particularly to obtain the roughness measurements.

An atomic force microscope (AFM) (Dimension 3000 AFM, Digital Instruments, USA) was used to measure the roughness of samples A and B. A silicon tip was used for scanning and images were collected in air, in the tapping mode. A scan area of 2×2 μm was used for all roughness measurements. A total of three independent measurements were performed randomly at different locations on the samples and an average value was taken for each sample. The results obtained are shown in Table 1 below.

TABLE 1
Table showing the results of the surface roughness of samples A and B.

| Sample | RMS Surface Roughness (nm) |
|---|---|
| A | 1.24 ± 0.05 |
| B | 0.74 ± 0.03 |

It can be seen from Table 1 that the magnetic layer comprising the mixed layer results in a smoother surface, which is advantageous in applications such as hard disk drives.

### Example 5

An experiment was carried out on samples B and D of Example 1 to analyse the thermal stability of the samples. In particular, laser heating tests were conducted to evaluate the thermal stability of sample B for its applicability to heat-assisted magnetic recording (HAMR) using a 780 nm single-mode continuous-wave laser. An infrared objective with numerical aperture (NA) of 0.42 was used to focus a 40 mW laser beam onto each sample which was rotated by an airbearing spindle at 2000 rpm at a track radius of 27 mm. The test duration for each sample was 5 minutes corresponding to 10000 heating cycles. Conductive atomic force microscopy (CAFM) was performed after the laser heating test in order to evaluate the surface change. The CAFM (Digital Instruments, DI 3000) equipped with a cobalt/chromium coated tip of 20 nm radius and a current preamplifier with a maximum amplification of 0.1 nA/V was used to perform the conductivity measurements in the contact mode. During the CAFM scan, a constant voltage bias in the range of 0.1 to 1 V was applied between the tip and the substrate and both the topography of the sample and the conducting current image through the film were recorded for each sample. The bias voltage and preamplifier magnification were tuned for each sample to obtain good image contrast.

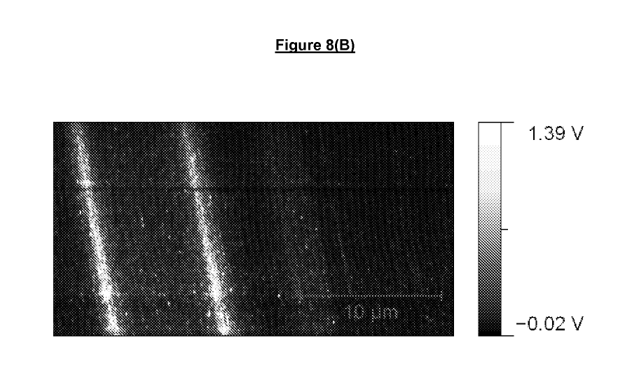

FIGS. 8(A) and (B) show the CAFM images obtained for samples B and D, respectively. As seen from FIGS. 8(B), an increase in the conductivity of the surface was observed for sample D which may be due to the degradation of the lubricant layer and the graphitization of the protective carbon overcoat. However, from FIG. 8(A), it can be seen that there was no increase in conductivity for sample B, thus showing that the mixed layer resulted in an improvement in the thermal stability of the magnetic layer.

1. A method comprising embedding energetic ions in a surface of a hard disk drive to form a mixed layer.

2. The method according to claim 1, wherein the embedding is in a surface of a magnetic recording medium and/or head of the hard disk drive.

3. The method according to claim 1, wherein the embedding is by filtered cathodic vacuum arc (FCVA) process and/or wherein the energetic ions have ion energy in the range 50-500 eV.

4. (canceled)

5. The method according to claim 1, wherein the embedding comprises embedding energetic ions to a depth of ≦2 nm in the surface of the hard disk drive.

6. The method according to claim 1, wherein the energetic ions are selected from the group consisting of: carbon ions, silicon ions, titanium ions, chromium ions, and a combination thereof.

7. The method according to claim 1, wherein the method further comprises depositing a protective layer on the mixed layer comprising diamond-like carbon (DLC).

8. (canceled)

9. The method according to claim 7, wherein the step of depositing a protective layer comprises depositing the protective layer to a thickness of ≦0.5 nm using a FCVA process.

10. (canceled)

11. The method according to claim 1, further comprising depositing a lubricant layer on the mixed layer.

12. The method according to claim 7, further comprising depositing a lubricant layer on the protective layer.

13. The method according to claim 11, wherein the depositing a lubricant layer is by di-coating or vapour deposition process of perfluoropolyethers, perfluoropolyalkylethers, or combinations thereof.

14. (canceled)

15. A hard disk drive comprising a mixed layer prepared according to the method of claim 1.

16. A hard disk drive comprising a magnetic recording medium and a head, wherein the magnetic recording medium and/or the head comprises a mixed layer embedded in the magnetic recording medium or the head.

17. The hard disk drive according to claim 16, wherein the magnetic recording medium comprises:
a substrate; and
a magnetic layer disposed in on the substrate,
wherein the magnetic layer comprises two layers, a lower magnetic layer of magnetic medium for recording information contacting the substrate and the mixed layer on the lower magnetic layer.

18. The hard disk drive according to claim 16, further comprising a lubricant layer disposed on the mixed layer.

19. The hard disk drive according to claim 16, further comprising a protective layer disposed on the mixed layer, between the mixed layer and a lubricant layer.

20. (canceled)

21. The hard disk drive according to claim 19, wherein the protective layer comprises diamond-like carbon (DLC).

22. The hard disk drive according to claim 19, wherein the protective layer has a thickness of ≦0.5 nm.

23. The hard disk drive according to claim 19, wherein the mixed layer has a thickness of ≦2 nm.

24. The hard disk drive according to claim 18, wherein the lubricant layer is composed of any one of perfluoropolyethers, perfluoropolyalylethers, or combinations thereof.

25. The hard disk drive according to claim 16, wherein the magnetic recording medium comprising the mixed layer has a coefficient of friction ≦0.5 nm.
